(19) United States
(12) Patent Application Publication
(10) Pub. No.: US 2008/0248454 A1
(43) Pub. Date: Oct. 9, 2008

(54) REMOTE LABS FOR INTERNET-DELIVERED, PERFORMANCE-BASED CERTIFICATION EXAMS

(76) Inventors: Benjamin H. Briggs, Austin, TX (US); Ori Pomerantz, Austin, TX (US)

Correspondence Address: IBM CORP (YA);C/O YEE & ASSOCIATES PC, P.O. BOX 802333, DALLAS, TX, 75380, US

(21) Appl. No.: 11/697,028

(22) Filed: Apr. 5, 2007

(51) Int. Cl. G09B 3/00

(52) U.S. Cl. 434/350

(57) ABSTRACT

A computer implemented method, apparatus, and computer program product for presenting an internet-delivered, performance-based certification exam to a user. The process requests connection details for a remote computing server in response to receiving a login from the user. The process transmits a web form to the user, wherein the web form presents an objective portion of the certification exam to the user. The process initiates a remote computing client to present a practical portion of the certification exam to the user, and responsive to receiving the completed certification exam from the user, the process calculates a score for the certification exam according to a verification script.

### BACKGROUND OF THE INVENTION

1. Field of the Invention

The present invention relates generally to an improved data processing system, and in particular to a computer implemented method and apparatus for presenting a certification exam to a user. Still more particularly, the present invention relates to a computer implemented method, apparatus, and computer usable program product for utilizing remote labs for internet-delivered, performance-based certification exams.

2. Description of the Related Art

A professional certification is a designation earned by a user to signify that the user is qualified to perform a certain task or job. The professional certification, which is often awarded by a product manufacturer, indicates that the holder of the certification possesses a particular knowledge, skill, or ability. To obtain a professional certification, a user is often required to pass a certification exam.

A certification exam can be an objective test, a practical test, or a combination of the two. Often, where a certification exam consists of both an objective test and a practical test, the user is required to first pass the objective portion before taking the practical portion. For example, to obtain a CISCO™ Certified Internetwork Expert certification, a user is required to successfully pass a written objective test before taking the required practical test. The objective portion of the certification exam, often presented as a multiple choice test, measures a user's knowledge of theory and ability to memorize facts. The practical portion, often referred to as “a lab,” is often presented to the user as a series of predetermined scenarios that the user is required to manage. The lab tests a user's ability to apply the theory in practical situations.

The objective test portion of a certification exam can be easily administered to a large audience at a number of easily accessible, proctored testing centers. The testing center often consists of a number of secure computer terminals with functionality limited only to providing the objective test. The testing center usually employs a testing proctor who verifies a candidate's identity, logs the candidate into the testing session, and monitors the testing room to prevent cheating. Typically, this testing proctor has no expertise or knowledge of the tests being administered. The testing center may be affiliated with or operated by a certification provider, such as Thomson Prometric™ or Pearson VUE™. Because of the ease at which the objective portion of the certification exam can be administered, the objective test can be completed in a short amount of time and for a relatively small fee when compared to its practical test counterpart.

Currently, users desiring to take a practical test portion of a certification exam invest more time and money than required for an objective test portion because the practical test portions are less accessible and more difficult to administer. For example, a user taking a practical test is often required to travel to one of a limited number of testing centers to perform the test under supervision of a professional examiner. The professional examiner is typically an instructor or expert in the tested subject matter. The professional examiner may charge a fee substantially higher than that of the testing center proctor.

In addition, before the user can even take the practical test portion of the certification exam, the user may be required to spend an additional day traveling to the test location. For instance, in order for a user to attain the CISCO™ Certified Internetwork Expert certification, the user is required to travel to one of ten CISCO™ locations worldwide to take the lab. In addition to the limited number of testing centers, the eight-hour exam is only offered a limited number of times each year. Because these practical tests are more difficult to administer, the cost of taking such a test can amount to thousands of dollars. Furthermore, with a limited number of available testing centers and qualified examiners, access to the practical portion of the certification exam may be greatly limited.

The requirement for a user to travel to testing locations to take the practical certification exam imposes upon the user a financial burden. In addition, the user is often required to allocate more time to take a practical certification exam than an objective certification exam in order to account for travel.

### SUMMARY OF THE INVENTION

The illustrative embodiments described herein provide a computer implemented method, apparatus, and computer usable program product for presenting an internet-delivered, performance-based certification exam to a user. The process requests connection details for a remote computing server in response to receiving a login from the user. The process transmits a web form to the user, wherein the web form presents an objective portion of the certification exam to the user. The process initiates a remote computing client to present a practical portion of the certification exam to the user, and responsive to receiving the completed certification exam from the user, the process calculates a score for the certification exam according to a verification script.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network data processing system in which illustrative embodiments may be implemented;

FIG. 2 is a block diagram of a data processing system in which the illustrative embodiments may be implemented;

FIG. 3 is a block diagram of a data processing system in accordance with an illustrative embodiment; and

FIG. 4 is a flowchart of a process for presenting a certification exam to a user in accordance with an illustrative embodiment.

### DETAILED DESCRIPTION OF THE PREFERRED EMBODIMENT

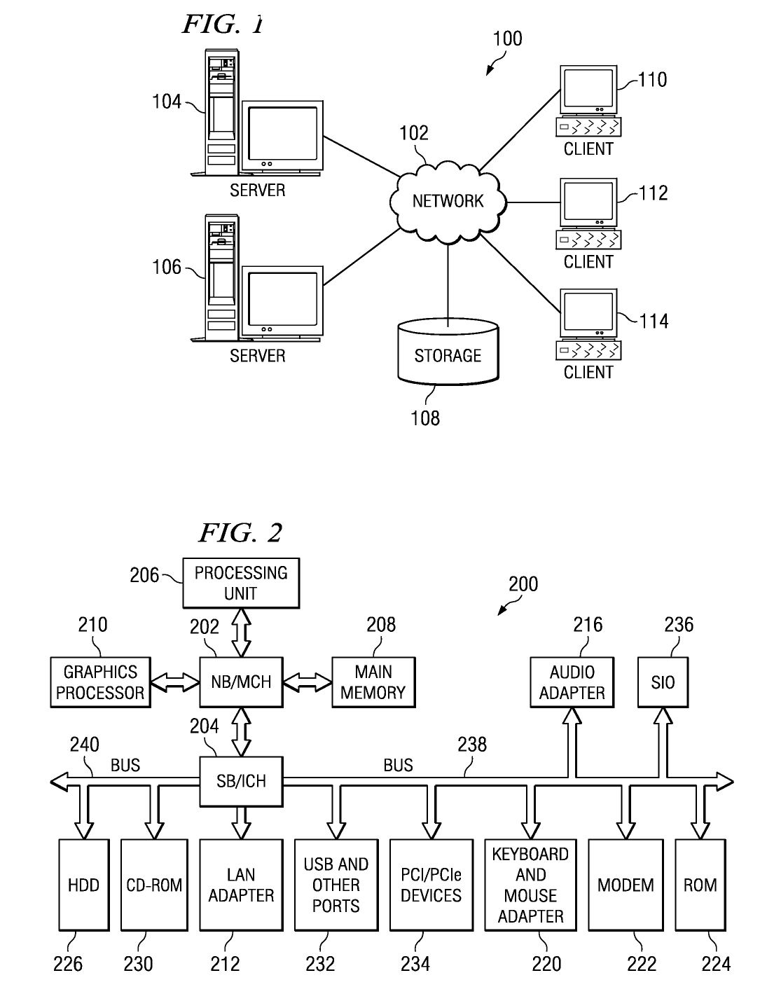

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including a north bridge and memory controller hub (NB/MCH) 202 and a south bridge and input/output (I/O) controller hub (SB/ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the NB/MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238, and hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The illustrative embodiments described herein provide a computer implemented method, apparatus, and computer usable program product for presenting an internet-delivered, performance-based certification exam to a user. The process requests connection details for a remote computing server in response to receiving a login from the user. The process transmits a web form to the user, wherein the web form presents an objective portion of the certification exam to the user. The process initiates a remote computing client to present a practical portion of the certification exam to the user. The remote network computing client may be initiated as an applet in the web form, or as an applet in another web form. In an alternate embodiment, the remote network computing client may be initiated independent of a web form, as an application in a computing device. Responsive to receiving the completed certification exam from the user, the process calculates a score for the certification exam according to a verification script.

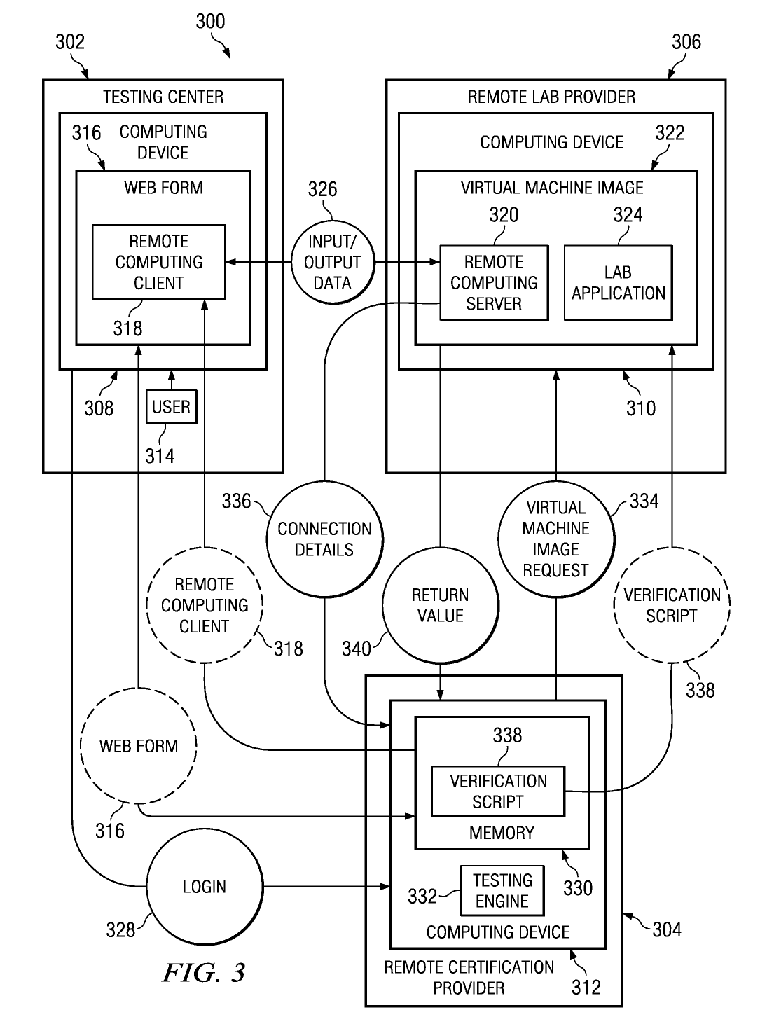

Turning now to FIG. 3, a block diagram of a data processing system is depicted in accordance with an illustrative embodiment. Data processing system 300 is a data processing system, such as data processing system 100 in FIG. 1.

The components of data processing system 300 are located at testing center 302, remote certification provider 304, and remote lab provider 306. Specifically, with respect to the illustrative example depicted in FIG. 3, the components of data processing system 300 include computing devices 308, 310, and 312. Computing devices 308, 310, and 312 are computing devices, such as server 104 and client 110 in FIG. 1.

Testing center 302 is the physical location at which user 314 is located while taking a certification exam. In most instances, testing center 302 is a proctored testing center that is operated by or affiliated with a certification provider. Similarly, remote certification provider 304 is a physical location, such as the offices of a certification provider, or the location at which the certification provider's computer servers are located. Although in this illustrative example in FIG. 3, testing center 302 and remote certification provider 304 are depicted as separate locations, in an alternate embodiment testing center 302 and remote certification provider 304 may be found at the same location. As with testing center 302 and remote certification provider 304, remote lab provider 306 is also a location that may include one or more servers that hosts or runs lab images used for presenting certification exams.

Testing center 302 contains computing device 308 that is operable by user 314 to take a certification exam. In one embodiment, computing device 310 may be a “dumb terminal.” A dumb terminal is a computing device having limited functionality, generally restricted to displaying output data to a user and receiving input data from a user, but lacking the capability to process the data. Instead, the data is transmitted to another computing device, such as computing device 312, for processing.

The various components of data processing system 300 work in conjunction to provide user 314 a certification exam. In this illustrative example in FIG. 3, the certification exam is a two-part exam consisting of an objective test portion and a practical test portion. The objective test portion of the certification exam is presented to user 314 in web form 316. In these illustrative embodiments, web form 316 is an interface, such as a graphical user interface, which contains test questions that form the basis of the objective test portion of the certification exam. The test questions may be presented to user 314 in the form of graphical and/or textual data. In addition, web form 316 may include interface elements, such as text fields, radio buttons, check boxes, drop-down lists, or any other number of elements with which user 314 may interact in order to generate answers to the test questions provided in web form 316.

The practical test portion of the certification exam is presented to user 314 via a remote computing system. The remote computing system of data processing system 300 includes remote computing client 318 and remote computing server 320. A remote computing system, in these examples, is a desktop sharing application that executes concurrently on two computing devices and allows a user operating one computing device to remotely interact with another computing device. The remote computing system includes a remote computing server and a remote computing client.

A user operates a local computing device, such as computing device 308, on which a remote computing client is executing. The input data generated by a user operating input devices, such as a keyboard and mouse, is transmitted to the remote computing device hosting the remote computing server. Meanwhile, the remote computing server relays back to the remote computing client screen updates that change in response to the newly received input data. Utilizing this remote computing system, the user is able to interact with and/or control an application executing on the remote computing device as though the application were executing on the local computer. The application may include, for example, a software application for generating a practical test portion of a certification exam.

In particular, with respect to the illustrative example in FIG. 3, the remote computing system of data processing system 300 includes remote computing client 318 and remote computing server 320. In this depicted example, user 314 is presented the practical test portion of a certification exam in remote computing client 318. Remote computing client 318 may be initiated as an applet in web form 316. In an alternate embodiment, however, remote computing client 318 may be initiated in a separate web form or as a separate application executing on computing device 308.

Lab application 324 is the software application provided by the entity that created the certification exam administered to user 314. The execution of lab application 324 by virtual machine image 322 generates the test scenarios that form the practical test portion of the certification exam. User 314 may access and interact with lab application 324 via the transfer of input/output data 326 between remote computing server 320 and remote computing client 318. Input/output data 326 is the stream of data transmitted between computing device 308 and remote computing server 320. Input/output data 326 includes the input data generated by user 314 in the operation of the input controllers of computing device 308. Input/output data 326 also includes the screen updates presented to user 314 at computing device 308 which originates from remote computing server 320.

In this illustrative example, remote computing server 320 is hosted by virtual machine image 322. Virtual machine image 322 is an emulation of a computer or computing environment. The emulation includes one or more operating systems and applications that, when executed in conjunction with a virtual image creation program, may be used or accessed by a user utilizing a virtual image reader or player program. Virtual machine image 322 is one or more virtual machine images, each of which hosts a remote computing server and stores a copy of lab application 324. A virtual machine image is utilized to host remote computing servers to minimize the number of computing devices that remote lab provider 306 is required to maintain.

For example, computing device 310 may run multiple instances of virtual machine images. Each virtual machine image is capable of hosting a single remote computing server to administer a lab application to a user. However, if remote computing server 320 is hosted by computing device 310, remote lab provider 306 would require a separate computing device for each user at testing center 302 taking a certification exam having a practical test portion. However, in alternate embodiments, remote computing server 320 may be hosted by computing device 310. In this alternate embodiment, computing device 310 would also store lab application 324.

When user 314 is ready to take the certification exam, user 314 generates login 328 to initiate the transmission of web form 316 from memory 330 of computing device 312 to user 314 operating computing device 308. Login 328 is any form of identification unique to user 314. For example, login 328 may consist of a username and password, or a pin number selected by or assigned to user 314. Preferably, sometime prior to the test date, login 328 is registered with the certification provider operating remote certification provider 304 so that login 328 may be stored in memory 330. Memory 330 is any type of memory, such as flash memory, equivalent non-volatile memory, optical disk drive, or any other known or available form of memory.

On the day of the exam, after user 314 generates login 328, testing engine 332 authenticates the identity of user 314 before delivery of the certification exam. The authentication of login 328 may be performed by comparing login 328 generated on the day of the exam with a previously registered copy of login 328 stored in memory 330. Testing engine 332 is a multifunctional software application that performs a variety of functions in computing device 312. For example, in addition to processing login 328 and transmitting web form 316 to computing device 308, testing engine 332 also submits virtual machine image request 334 to computing device 310 in response to receiving login 328 and requests connection details 336. Virtual machine image request 334 is a data structure having instructions for prompting computing device 310 to initiate virtual machine image 322.

Once virtual machine image 322 is initiated, testing engine 332 receives the requested connection details 336 from computing device 310. Connection details 336 is a data structure containing information usable by remote computing client 318 to establish a connection to remote computing server 320. For example, connection details 336 may include a port number and/or an IP address.

When user 314 is ready to take the practical test portion of the certification exam, testing engine 332 initiates remote computing client 318 in computing device 308. Specifically, remote computing client is transmitted from memory 330 for execution on computing device 308. In one embodiment, remote computing client 318 is implemented as an applet in web form 316. In alternate embodiments, remote computing client 318 is initiated as an applet in a separate web form, or as a separate application in computing device 308.

Remote computing client 318 connects to remote computing server 320 by utilizing connection details 336 received from computing device 310. While user 314 is completing the tasks prompted by lab application 324, remote computing client 318 and remote computing server 320 exchange input/output data 326. In particular, remote computing server 320 sends screen updates to remote computing client 318. Concurrently, remote computing client 318 transmits keyboard and mouse movements to remote computing server 320 for interacting with virtual lab application 324.

User 314 may signify the completion of the certification exam by interacting with an interface element of web form 316. For example, user 314 may select a virtual button on web form 316 labeled “End”. Upon completing the certification exam, testing engine 332 terminates the transmission of input/output data 326. Thereafter, testing engine 332 transmits a copy of verification script 338 to virtual machine image 322 to allow virtual machine image 322 to determine how many scenarios of the practical test portion that user 314 managed correctly. Verification script 338 is an application that checks the current state of lab application 324 to ensure user 314 modified lab application 324 in accordance with the exam requirements.

Virtual machine image 322 utilizes verification script 338 to calculate a score for the completed certification exam. In particular, virtual machine image 322 uses verification script 338 to determine the number of practical exam scenarios user 314 managed correctly. Thereafter, virtual machine image 322 transmits return value 340 to computing device 312. Return value 340 is a data structure containing values indicating the number of correctly managed scenarios. Similar test values are calculated by testing engine 332 for the objective test portion of the certification exam presented via web form 316.

Testing engine 332 combines the scores for both the objective portion and practical portion of the certification exam to calculate a score for the completed certification exam. To protect the transmission of verification script 338 and return value 340 from possible tampering, computing device 310 and virtual machine image 322 may implement secure shell protocol.

In addition, return value 340 may also contain exam performance data that may or may not be used in calculating a certification exam score for user 314. Exam performance data is data generated by user 314 in the completion of the practical test portion of the certification exam. The exam performance data may include, for example, information relating to the amount of time user 314 spent to complete a particular scenario, whether user 314 attempted to implement corrective actions after an initial response was recorded, or any other relevant information that may be collected during the completion of the certification exam by user 314.

In the illustrative example in FIG. 3, web form 316 is transmitted from computing device 312 to user 314 operating computing device 308. In an alternate embodiment, however, web form 316 may be provided to user 314 from a third party source. The third party source may be, for example, a database owned by the entity responsible for generating the certification exam. In another embodiment, rather than implementing a remote computing system to allow communication between computing device 308 and computing device 310, a remote access application, such as Citrix™, may be implemented.

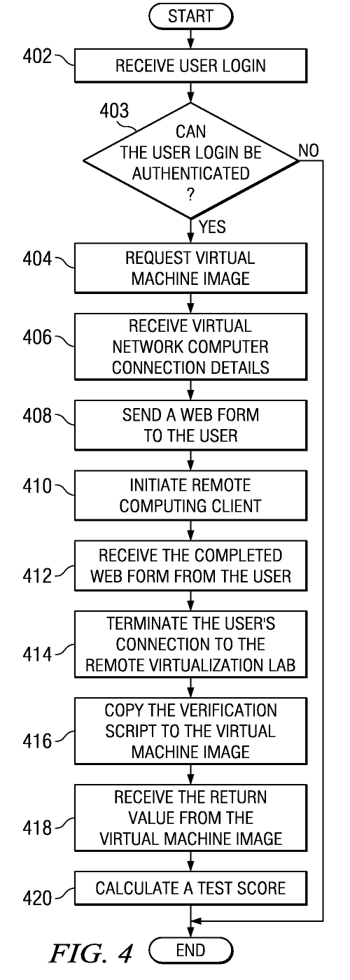

Turning now to FIG. 4, a flowchart of a process for presenting a certification exam to a user is depicted in accordance with an illustrative embodiment. In this illustrative embodiment in FIG. 4, the process may be performed by software component, such as testing engine 332 in FIG. 3.

The process begins by receiving a user login (step 402). The process makes the determination as to whether the user login can be authenticated (step 403). If the process makes the determination that the user login can be authenticated, then the process requests a virtual machine image (step 404) and receives virtual network computer connection details (step 406). However, if the process makes the determination that the user login cannot be authenticated, then the process terminates thereafter.

The process administers the certification exam by sending a web form to the user (step 408). Once the user has completed the objective portion of the test, the process initiates a remote computing client to present to the user the practical portion of the certification exam (step 410). The remote computing client may be initiated in the web form as an applet, in a separate web form, or as a separate application.

Once the user completes the certification exam, the process receives the completed web form from the user (step 412), and terminates the user's connection to the remote virtualization lab (step 414). Thereafter, the process copies the verification script to the virtual machine image (step 416) and then receives a data structure containing a return value from the virtual machine image (step 418). The process calculates a test score using the return value (step 420) and the process terminates thereafter.

Thus, the illustrative embodiments described herein provide a computer implemented method, apparatus, and computer usable program product for presenting an internet-delivered, performance-based certification exam to a user. The process requests connection details for a remote computing server in response to receiving a login from the user. The process transmits a web form to the user, wherein the web form presents an objective portion of the certification exam to the user. The process initiates a remote computing client to present a practical portion of the certification exam to the user, and responsive to receiving the completed certification exam from the user, the process calculates a score for the certification exam according to a verification script.

Using the method and apparatus disclosed herein, certification exams consisting of both an objective portion and a practical, performance-based portion can be easily administered to users worldwide by testing center proctors who are not required to have knowledge of the subject matter of the test they are administering. The ease at which the certification exam can be administered will result in lower costs for the user and eliminate the need to travel to distant testing centers.

The invention presented herein can take the form of an entirely hardware embodiment, an entirely software embodiment, or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, semiconductor system (or apparatus or device), or a propagation medium. Examples of a computer-readable medium include a semiconductor, a solid state memory, a magnetic tape, a removable computer diskette, a random access memory (RAM), a read-only memory (ROM), a rigid magnetic disk or an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for presenting a certification exam to a user, the computer implemented method comprising:
responsive to receiving a login of the user, requesting connection details for a remote computing server;
transmitting a web form to the user, wherein the web form presents an objective portion of the certification exam to the user;
initiating a remote computing client to present a practical portion of the certification exam to the user; and
responsive to receiving a completed certification exam from the user, calculating a score for the completed certification exam according to a verification script.

2. The computer implemented method of claim 1 further comprising:
copying the verification script to the virtual computing platform image.

3. The computer implemented method of claim 1, wherein the remote computing client is initiated as an applet.

4. The computer implemented method of claim 3, wherein the remote computing client is initiated in the web form.

5. The computer implemented method of claim 1, wherein the remote computing client is initiated as an application.

6. The computer implemented method of claim 1, wherein the remote computing server is hosted by a virtual computing platform image.

7. The computer implemented method of claim 1 further comprising:
receiving exam performance data of the user, wherein the exam performance data is generated by the user during completion of the certification exam.

8. A computer program product comprising:
computer usable program code for presenting a certification exam to a user, the computer program product comprising:
computer usable program code for requesting connection details for a remote computing server in response to receiving a login of the user;
computer usable program code for transmitting a web form to the user, wherein the web form presents an objective portion of the certification exam to the user;
computer usable program code for initiating a remote computing client to present a practical portion of the certification exam to the user; and
computer usable program code for calculating a score for a completed certification exam according to a verification script in response to receiving the completed certification exam from the user.

9. The computer program product of claim 8 further comprising:
computer usable program code for copying the verification script to a virtual computing platform image, wherein the virtual computing platform image is hosting the remote computing server.

10. The computer program product of claim 8, wherein the remote computing client is initiated as an applet.

11. The computer program product of claim 10, wherein the remote computing client is initiated in the web form.

12. The computer program product of claim 8, wherein the remote computing client is initiated as an application.

13. The computer program product of claim 8, wherein the remote computing server is hosted by a virtual computing platform image

14. The computer program product of claim 8, further comprising:
computer usable program code for receiving exam performance data of the user, wherein the exam performance data is generated by the user during completion of the certification exam.

15. A system for presenting a certification exam to a user, the system comprising:
a first computing device operable by a user for taking the certification exam;
a second computing device for simulating a virtual machine image, wherein the virtual machine image hosts a remote computing server; and
a third computing device for requesting connection details for the remote computing server in response to receiving a login of the user; transmitting a web form to the user, wherein the web form presents an objective portion of the certification exam to the user; initiating a remote computing client to present a practical portion of the certification exam to the user; and calculating a score for a completed certification exam according to a verification script in response to receiving the completed certification exam from the user.
